(19) United States
(12) Patent Application Publication
(10) Pub. No.: US 2025/0105616 A1
(43) Pub. Date: Mar. 27, 2025

(54) SWITCHING DEVICE AND METHOD FOR PROTECTING AN ELECTRICAL LOAD AGAINST OVERCURRENT

(71) Applicant: Siemens Aktiengesellschaft, München (DE)

(72) Inventors: Thomas List, Sulzbach-Rosenberg (DE); Stefan Langen, Kastl (DE); Julian Stefan Breiter, Regensburg (DE); Stefan Zitzler, Schwandorf (DE)

(21) Appl. No.: 18/899,061

(22) Filed: Sep. 27, 2024

(30) Foreign Application Priority Data
Sep. 27, 2023 (DE) 10 2023 209 434.7

(51) Int. Cl. H02H 3/08

(52) U.S. Cl. CPC H02H 3/08

(57) ABSTRACT

A switching device protects an electrical load against overcurrent. A load current path from a current source to the load is connected through a semiconductor switch. In the on-state of the switch, the current is permitted to flow. In the off-state, the load current is blocked. A control circuit is configured to switch the semiconductor switch in response to a switching signal. The current in the load current path is measured. A controller execute an individual function or a combination of two or more predefined functions depending on an operating mode of the electrical load. The functions compare a current intensity and/or a temporal current profile of the current through the load current path with defined threshold values. The control circuit is driven by the switching signal that depends on one or more results of the executed functions to selectively switch off the semiconductor switch.

### CROSS-REFERENCE TO RELATED APPLICATION

This application claims the priority, under 35 U.S.C. § 119, of German Patent Application DE 10 2023 209 434.7, filed Sep. 27, 2023; the prior application is herewith incorporated by reference in its entirety.

### FIELD AND BACKGROUND OF THE INVENTION

The present invention relates to a switching device for protecting an electrical load against overcurrent and to a method.

The term “overcurrent” describes a state in a circuit in which the normal load current in a conductor of the circuit is exceeded. Overcurrent may be caused by an overload or a short circuit; see, for example, DIN VDE 0100-430:2010-10. An overload current that is only just above the maximum continuing permissible current of the conductor only heats up the conductor after a relatively long period at an impermissibly high temperature. In contrast, in the case of a short-circuit current, an impermissibly high temperature in the conductor may be reached even at fractions of an electrical half-wave (10 ms at 50 Hz AC).

Miniature circuit breakers are used in low-voltage grids to protect conductors from damage caused by heating as a result of overcurrent. In the case of overload, a bimetal that bends when heated by the current flowing through and trips a disconnection mechanism (thermal tripping) can be used for the tripping process. In the case of a short circuit, an electromagnet, through which current flows and which establishes a magnetic field within a few milliseconds, can be used for the tripping process, the magnetic field tripping a disconnection mechanism (electromagnetic tripping).

### SUMMARY OF THE INVENTION

There is a great need for improvements in overcurrent protection due to extensive electrification and automation throughout the world and the high risks for humans, animals and material assets caused by overcurrent. It is thus an object of the present invention to improve overcurrent protection.

With the above and other objects in view there is provided, in accordance with the invention, a switching device for protecting an electrical load against overcurrent, comprising:
a load current input for connection to a load current line from a current source and a load current output for connection to a load current line to the electrical load;
a load current path for conducting a current from said load current input to said load current output;
a semiconductor switch connected in said load current path, said semiconductor switch being configured to permit the current through said load current path when said semiconductor switch is switched on and to block the current through the load current path when said semiconductor switch is switched off;
a control circuit configured to switch said semiconductor switch on or off in response to a switching signal;
a current measuring arrangement for recording the current through said load current path;
a controller configured:
   to execute an individual function or a combination of two or more functions of at least two predefined functions depending on an operating mode of the electrical load, the functions comparing at least one of a current intensity or a temporal current profile of the current through said load current path with defined threshold values; and
   to drive said control circuit using a switching signal in dependence on one or more results of the one or more executed functions to switch off said semiconductor switch

The switching device is used to protect an electrical load, for example an electric motor, against overcurrent. The term “switching device” is used here and in the following text as a short form of switching and protective device, which is connected upstream of an electrical consumer that is connected to an electrical grid. A switching and protective device of this kind comprises at least one electrically switchable switching element and, in the event of a fault, isolates the or each connected consumer—or generally a load region—from the feed side. This is the protective effect of the switching and protective device. In the same way, the switching and protective device can also be used to disconnect the load region originating from the switching and protective device and thus disconnect the or each consumer connected to the switching and protective device by way of a switching command that acts on the switching and protective device. This is the switching effect of the switching and protective device.

The switching device comprises a load current input, to which a grid-side load current line can be connected in order to connect the load current input to a current source, for example an electrical grid. The switching device furthermore comprises a load current output, to which a load current line can be connected in order to connect the load current output to the electrical load. The switching device comprises a load current path, through which current can be conducted from the load current input to the load current output.

The switching device comprises a semiconductor switch, which is connected in the load current path. In this case, the semiconductor switch permits current through the load current path when the semiconductor switch is switched on; in contrast, the semiconductor switch blocks current through the load current path when the semiconductor switch is switched off. The semiconductor switch is an electrically switchable switching element. For example, the semiconductor switch is an electrically switchable power semiconductor switch. The semiconductor switch may also be in the form of an interconnection of two power semiconductor switches that has the ability to conduct and block in a bidirectional manner.

The switching device comprises a control circuit, which is configured to switch the semiconductor switch on or off in response to a received switching signal. A switching state of the semiconductor switch can be influenced via a control input of the semiconductor switch, for example a gate input, and by means of a control signal that can be generated by the control circuit, which may be for example in the form of a control unit, and that is output to the control input of the semiconductor switch, and said switching state is influenced during operation of the switching device by means of a control signal generated by the control circuit and output to the control input; the semiconductor switch is switched to an open or closed state by means of the control signal.

The switching device comprises a current measuring arrangement for recording the current through the load current path. The current measuring arrangement used may be a current transducer, for example a Hall sensor, a measuring shunt, a compensation current transducer or similar.

The switching device comprises a controller. The controller is configured to execute an individual function or a combination of two or more functions of at least two predefined functions depending on an operating mode of the electrical load. The predefined functions compare a current intensity and/or a temporal current profile of the current through the load current path with defined threshold values and output the result of the comparison. The controller is furthermore configured to drive the control circuit using a switching signal depending on one or more results of the one or more executed functions so that the semiconductor switch is switched off.

With the above and other objects in view there is also provided, in accordance with the invention, a method for protecting an electrical load against overcurrent. The method comprises a step of recording a current through a load current path of a switching device. In this case, the load current path conducts the current from a load current input, to which a load current line from a current source is connected, to a load current output, to which a load current line to the electrical load is connected.

The method comprises a step of providing at least two predefined functions, which compare a current intensity and/or a temporal current profile of the current through the load current path with defined threshold values.

The method comprises a step of executing an individual function or a combination of two or more functions of the predefined functions. In this case, the execution of said functions is carried out depending on an operating mode of the electrical load.

And the method comprises a step of driving the control circuit using a switching signal. In this case, the driving is carried out depending on one or more results of the one or more executed functions. The driving is carried out so that a semiconductor switch that is connected in the load current path is switched off. In this case, the semiconductor switch permits current through the load current path when the semiconductor switch is switched on. And the semiconductor switch blocks current through the load current path when the semiconductor switch is switched off.

The invention is based on the concept that overcurrent protection is implemented as an SW or FW solution in a controller (SW=software; FW=firmware). The freely configurable execution of an individual function or a combination of two or more functions of the predefined functions makes it possible to logically combine the triggering of the semiconductor switch in a variety of ways or to influence same in terms of time. It is thus possible to provide instantaneous, very rapid disconnection, for example in the event of a short circuit. Due to the configurable execution of an individual function or a combination of two or more functions of the predefined functions, it is also possible to suppress instances of EMC interference or to somewhat deliberately delay limit value evaluations. This can ensure flexible overcurrent protection.

Advantageous embodiments and developments of the invention are specified in the dependent claims. In this case, the method according to the invention can also be developed according to the dependent device claims and vice versa.

According to one preferred configuration of the invention, the predefined set of at least two functions comprises a first function, used to continuously record the temporal current profile in the load current path, to compare same with a first current threshold value and to output the result of the comparison as the result of the function. Furthermore, the predefined set of at least two functions comprises a second function used to record the temporal current profile in the load current path at particular times, to compare the recorded current values with a second current threshold value and to output the result of the comparison as the result of the function. The predefined set of at least two functions also comprises a third function used to record the temporal current profile in the load current path at particular times, to compare a change in the current over time for the recorded current values with a current change threshold value and to output the result of the comparison as the result of the function. The interval between two successive times at which current values are recorded may be 1 to 2 μs; however, it may also be significantly longer, for example 100 μs. One advantage of this configuration is that different overcurrent identification algorithms can be activated depending on the operation of the electrical consumer: it is therefore possible to identify a short circuit and an overload and to distinguish these from one another. Another advantage of this configuration is that it allows diagnosis in the event of a fault.

According to another preferred configuration of the invention, the switching device comprises a command signal input, from which the controller can receive a switching command for switching the semiconductor switch. As a result, the switching and protective device can also be used to operationally disconnect the consumer that is connected to the switching and protective device by way of a switching command that acts on the switching and protective device. One advantage of this configuration is that in this way the switching and protective device functions as a switching device, such as a relay or a contactor for operationally switching an electrical consumer on or off.

According to again another preferred configuration of the invention, the switching device comprises an analog comparator by means of which the first function can compare a present current value of the current profile in the load current path with the first current threshold value. The analog comparator may be in the form of a unit of the controller. One advantage of this configuration is that current can be monitored continuously.

According to a further preferred configuration of the invention, the switching device comprises a digital comparator by means of which the second function can compare the recorded current values with the second current threshold value and/or the third function can compare the change in the recorded current values over time with the current change threshold value. The digital comparator may be in the form of a unit of the controller. One advantage of this configuration is that current can be monitored very flexibly.

According to again a further preferred configuration of the invention, the switching device comprises a data memory, in which algorithms of the functions can be stored, said algorithms defining the circumstances under which the controller outputs a switching signal to the control circuit. One advantage of this configuration is that current can be monitored very flexibly.

According to yet another preferred configuration of the invention, the method comprises providing the following three functions: a first function used to continuously record a temporal current profile in the load current path, to compare same with a first current threshold value and to output the result of the comparison as the result of the function; a second function used to record a temporal current profile in the load current path at particular times, to compare the recorded current values with a second current threshold value and to output the result of the comparison as the result of the function; a third function used to record a temporal current profile in the load current path at particular times, to compare a change in the current over time for the recorded current values with a current change threshold value and to output the result of the comparison as the result of the function. One advantage of this configuration is that current can be monitored very flexibly.

According to a further preferred configuration of the invention, in the method, a switching signal for switching off the semiconductor switch is transmitted to the control circuit if the result of the first function is that the current in the load current path exceeds the first current threshold value, or if the result of the second function is that at least one of the recorded current values of the temporal current profile in the load current path exceeds the second current threshold value, or if the result of the third function is that the change in current over time for the recorded current values exceeds the current change threshold value. One advantage of this configuration is that it is possible to react very flexibly to an overcurrent.

According to again a further preferred configuration of the invention, the electrical load is an electric motor and, in the method, the first function is activated during start-up of the electric motor and the combination of the first and second function or the combination of the first, second and third function is activated in rated operation of the electric motor. One advantage of this configuration is that the monitoring of the electric motor for an overcurrent is very flexible.

Although the invention is illustrated and described herein as being embodied in a switching device for protecting an electrical load against overcurrent, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic view of a protection device according to the invention;

FIG. 2 shows a flowchart of a first function;

FIG. 3 shows a flowchart of a second function;

FIG. 4 shows a flowchart of a third function;

FIG. 5 is a graph of a current profile of a motor start-up and a short-circuit;

FIG. 6 shows a current profile of an overload;

FIG. 7 shows a current profile of a short circuit;

FIG. 8 shows a current profile of an overload;

FIG. 9 is a schematic view of a setup of the switching device 1 that corresponds to the flowchart of FIG. 2;

FIG. 10 shows a setup of the switching device 1 that corresponds to the flowchart of FIG. 3; and

FIG. 11 shows a setup of the switching device 1 that corresponds to the flowchart of FIG. 4.

### DETAILED DESCRIPTION OF THE INVENTION

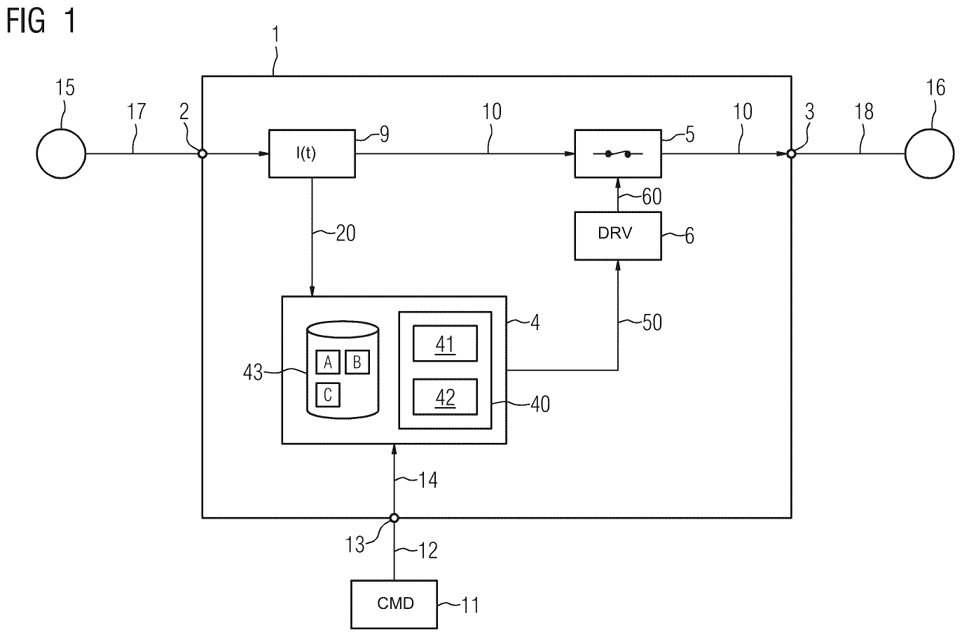

Referring now to the figures of the drawing in detail and first, in particular, to FIG. 1 thereof, there is shown a switching and protection device 1, which for the sake of simplicity is referred to as a protection device, for protecting an electrical load 16, for example an electric motor, against an overcurrent. The switching device 1 comprises a load current input 2, to which a load current line 17 from a current source 15, for example an electrical grid, is connected. The switching device 1 comprises a load current output 3, to which a load current line 18 to the electrical load 16 is connected. The switching device 1 comprises a load current path 10, through which current can be conducted from the load current input 2 to the load current output 3.

The switching device 1 comprises a semiconductor switch 5, which is connected in the load current path 10. The semiconductor switch 5 permits current through the load current path 10 when the semiconductor switch 5 is switched on. The semiconductor switch 5 blocks current through the load current path 10 when the semiconductor switch is 5 switched off. The switching device 1 comprises a control circuit 6, also referred to as a driver circuit, which is configured to switch the semiconductor switch 5 on or off in response to a received switching signal.

The switching device 1 comprises a current measuring arrangement 9 for recording the current through the load current path 10. The current measuring arrangement used may be a current transducer, for example a Hall sensor, a measuring shunt, a compensation current transducer or similar.

The switching device 1 comprises a controller 4. The controller 4 is configured to execute an individual function or a combination of two or more functions of at least two predefined functions A, B, C depending on an operating mode of the electrical load 16, said functions comparing a current intensity and/or a temporal current profile of the current through the load current path 10, which are recorded using the current measuring arrangement 9, with defined threshold values S1, S2, S3.

The controller 4 is configured to drive the control circuit 6 using a switching signal 50 depending on one or more results of the one or more executed functions A, B, C so that the semiconductor switch 5 is switched off.

The controller 4 comprises a microprocessor 40 and a data memory 43, in which the algorithms of the three predefined functions A, B, C are stored in a data format. The microprocessor 40 comprises a selection circuit 41 and an overcurrent detection circuit 42.

The switching device 1 furthermore comprises a command signal input 13, via which command signals 14 can be fed from an external command signal generator 11, for example a smart phone, a PC, a control unit or a control panel, to the controller 4. An externally produced command signal 14 of this kind can be used to trigger the controller 4 to produce a switching signal for switching the semiconductor switch 5 on or off irrespective of the measurement values from the current measuring arrangement 9 and to transmit said switching signal to the control circuit 6.

The switching device 1 is used to execute a method for protecting the electrical load 16 against overcurrent. The current measuring arrangement 9 records a current through the load current path 10 of the switching device 1 for this purpose. An individual function or a combination of two or more functions of the predefined functions A, B, C is executed depending on an operating mode of the electrical load 16. In this case, the functions A, B, C are configured to compare a current intensity and/or a temporal current profile of the current through the load current path 10 with defined threshold values. The controller 4 drives the control circuit 6 using a switching signal 50 depending on one or more results of the one or more executed functions A, B, C such that the semiconductor switch 5 is switched off: a) if the results of the one or more executed functions A, B, C are that the semiconductor switch 5 is to be switched off, the controller 4 drives the control circuit 6 using a switching signal 50 so that the control circuit 6 sends a control signal 60 to the semiconductor switch 5, which causes the semiconductor switch 5 to switch off; b) if the results of the one or more executed functions A, B, C show that the semiconductor switch 5 is not to be switched off, the controller 4 does not drive the control circuit 6 and the semiconductor switch 5 remains switched on.

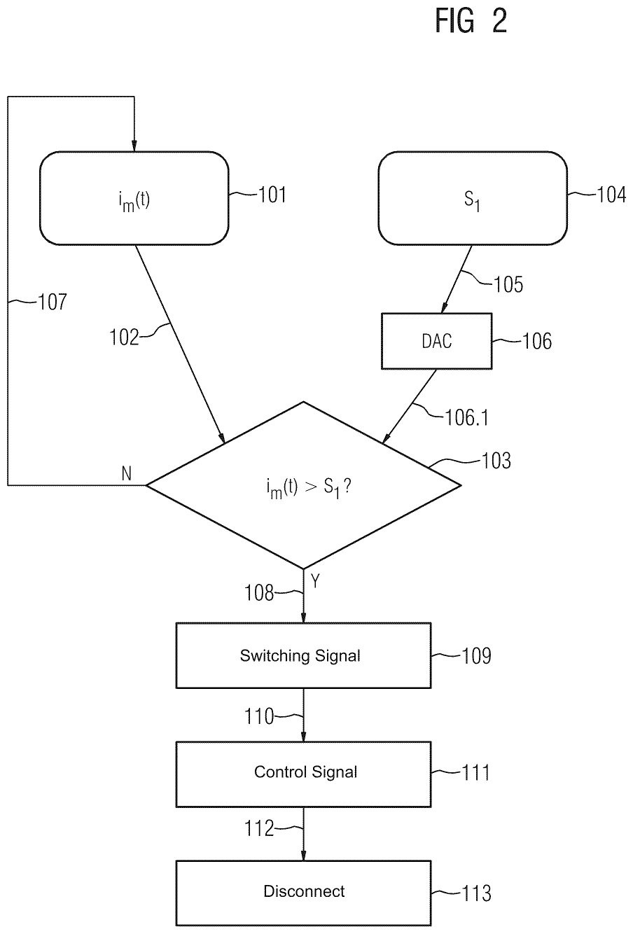

FIG. 2 shows an exemplary embodiment of a first function A in the

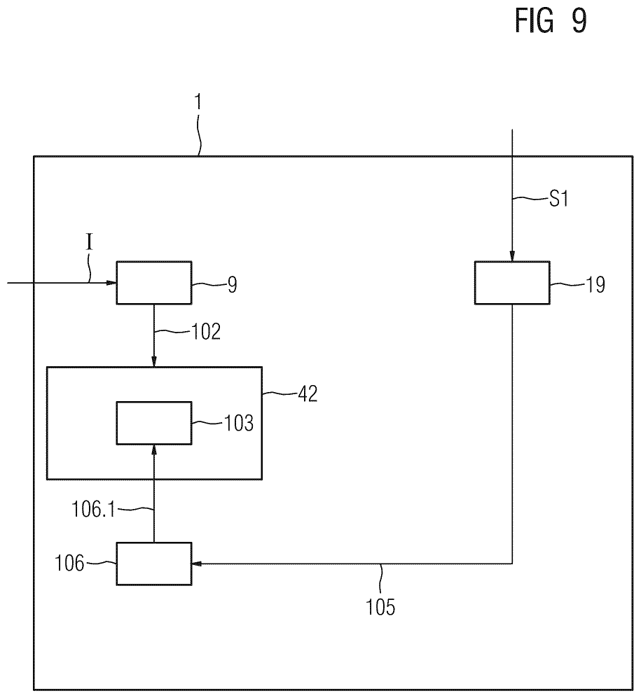

form of a flowchart. FIG. 9 shows a corresponding setup of the switching device 1.

The first function A compares the continuously recorded current profile with a current threshold value in an analog comparator. This function provides the quickest way to disconnect the semiconductor switch but does not enable any distinction between a short circuit and overload.

In this case, the current measuring arrangement 9 continuously records 101 the current profile I in the load current path 10. The recorded values are fed to an analog comparator 103 as analog values 102. The analog comparator 103 is part of an overcurrent detection circuit 42 of the controller 4. A first threshold value S1 is input 104 into the switching device 1 via an interface 19 of the switching device 1, is fed to a DAC 106 as a digital value 105 and from there is fed to the analog comparator 103 as an analog value 106.1. The current profile I is compared with the first threshold value S1 in the analog comparator 103. If the current profile I does not exceed the first threshold value S1 (“N”), the current measurement 101 is continued. If the current profile I does exceed the first threshold value S1 (“Y”), the overcurrent detection circuit 42 of the controller 4 produces 109 a switching signal 50, which is transmitted 110 to the control circuit 6. Triggered by the received switching signal 50, the control circuit 6 produces 111 a control signal 60, which is transmitted 112 to the semiconductor switch 5 and there leads to the semiconductor switch 5 being switched off 113.

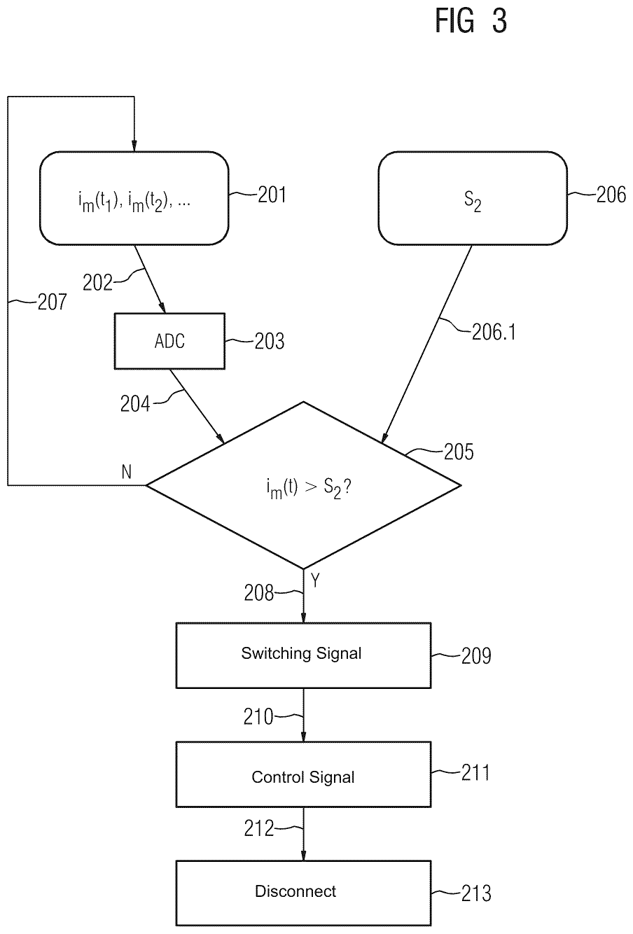

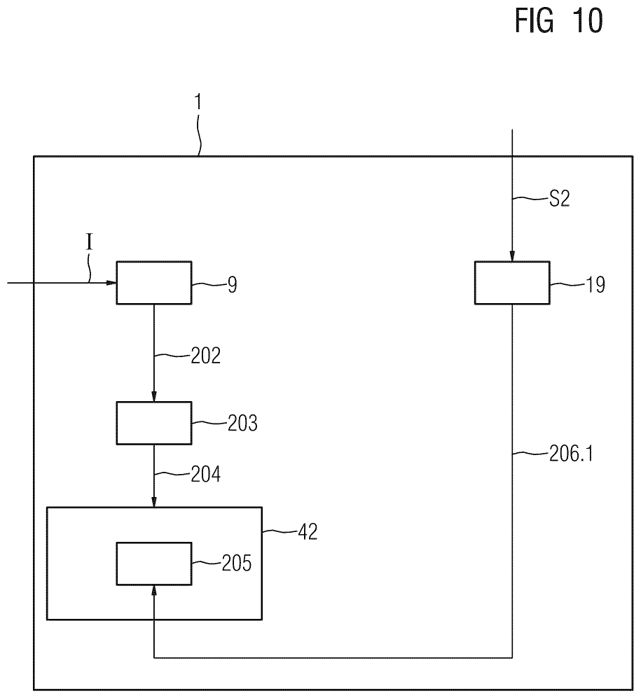

FIG. 3 shows an exemplary embodiment of a second function B in the form of a flowchart. FIG. 10 shows a corresponding setup of the switching device 1.

The second function B compares the values of the discontinuously sampled current profile with a current threshold value in a digital comparator. Said second function provides a slower way than function A for disconnecting the semiconductor switch. Said second function enables a distinction between a short circuit and overload; see FIG. 6.

In this case, the current measuring arrangement 9 samples 201 the current profile I in the load current path 10 continuously at separate times (“sampling”). The recorded current values are fed as analog values 202 to an ADC 203 and from there are fed as digital values 204 to a digital comparator 205. The digital comparator 205 is part of an overcurrent detection circuit 42 of the controller 4. A second threshold value S2 is input 206 into the switching device 1 via an interface 19 of the switching device 1 and is fed as a digital value 206.1 to the digital comparator 205. The recorded current values I1(t1), I2(t2), I3(t3), . . . are compared with the second threshold value S2 in the digital comparator 205. If the recorded current values I1(t1), I2(t2), I3(t3), . . . do not exceed (“N”) the second threshold value S2, the sampling 201 of the current is continued. If the recorded current values I1(t1), I2(t2), I3(t3), . . . do exceed (“Y”) the second threshold value, the overcurrent detection circuit 42 of the controller 4 produces 209 a switching signal 50, which is transmitted 210 to the control circuit 6. Triggered by the received switching signal 50, the control circuit 6 produces 211 a control signal 60, which is transmitted 212 to the semiconductor switch 5 and there leads to the semiconductor switch 5 being switched off 213.

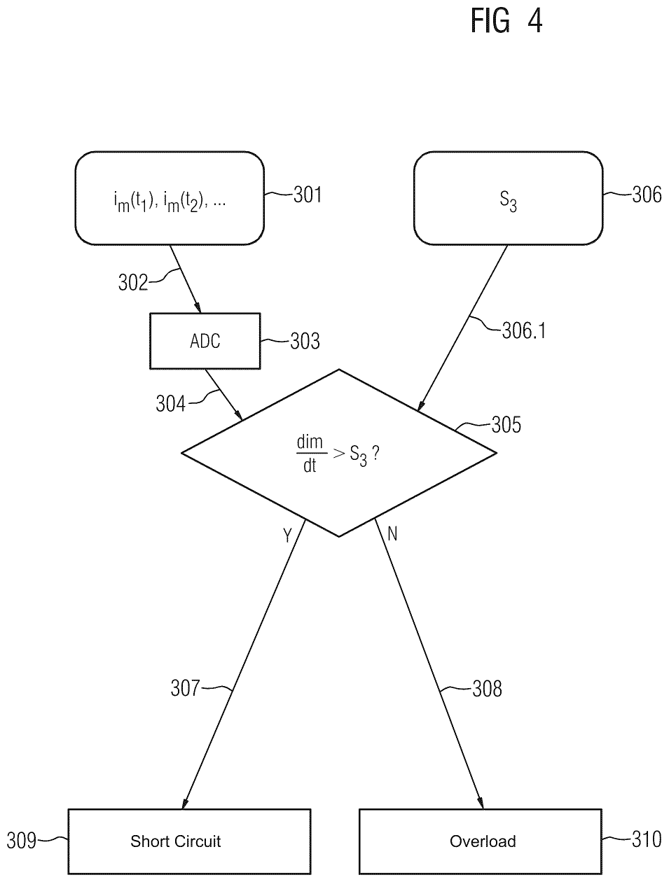

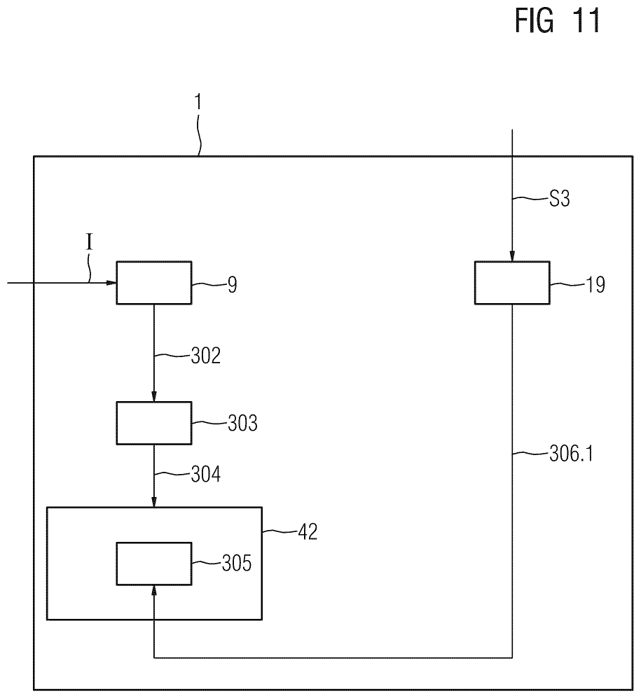

FIG. 4 shows an exemplary embodiment of a third function C in the form of a flowchart. FIG. 11 shows a corresponding setup of the switching device 1.

The third function C compares a change in the discontinuously sampled current profile over time with a current threshold value in a digital comparator. This function provides a slower way than function A to disconnect the semiconductor switch but does enable a distinction between short circuit and overload.

In this case, the current measuring arrangement 9 samples 301 the current profile I in the load current path 10 continuously at separate times (“sampling”). The recorded current values are fed as analog values 302 to an ADC 303 and from there are fed as digital values 304 to a digital comparator 305. The digital comparator 305 is part of an overcurrent detection circuit 42 of the controller 4. A third threshold value S3 is input 306 into the switching device 1 via an interface 19 of the switching device 1 and is fed as a digital value 306.1 to the digital comparator 305. A change dl/dt in the recorded current values I1(t1), I2(t2), I3(t3), . . . over time is compared with the third threshold value S3 in the digital comparator 305. If the change dl/dt in the recorded current values I1(t1), I2(t2), I3(t3), . . . over time does not exceed (“N”) the third threshold value S3, function C outputs the presence of an overload 310 as result. If the change dl/dt in the recorded current values I1(t1), I2(t2), I3(t3), . . . over time does exceed (“Y”) the third threshold value S3, function C outputs the presence of a short circuit 309 as result.

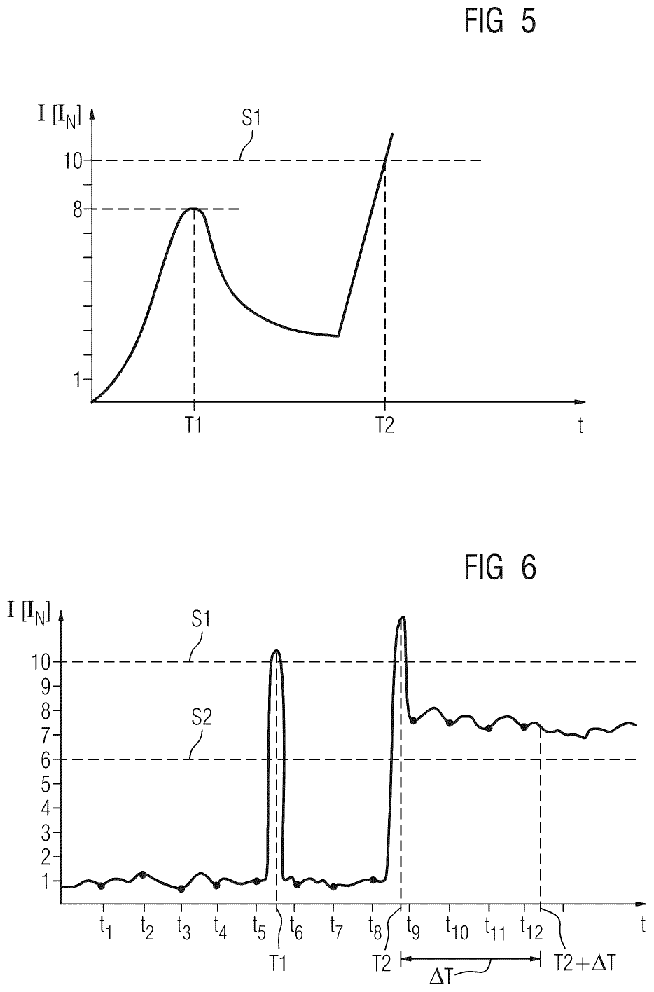

FIG. 5 shows a current profile of a motor start-up and a short-circuit. During start-up, a motor reaches a maximum current value of I=8×I_{N} (Iₙₒₘᵢₙₐₗ) at the time T1, wherein I_{N} is the rated value of the motor current in rated operation. Since the operating mode of the electric motor is a start-up of the motor, a selection circuit 41 of the controller 4 activates the first function A; the desire is to identify exclusively a “real” short circuit (I>first threshold value S1). For this purpose, a first threshold value of S1=10×I_{N} is defined in the analog comparator. The inrush current of I=8×I_{N} at the time T1 thus does not lead to the disconnection of the semiconductor switch, only the short circuit at the time T2 when the current in the load current path exceeds the first threshold value S1.

FIG. 6 shows a current profile of an overload. A motor is in continuous operation. Since the operating mode of the electric motor is rated operation of the motor, a selection circuit 41 of the controller 4 activates the second function B: As a result, it is possible that the semiconductor switch is not disconnected immediately upon a threshold value being exceeded, but only when a threshold value is exceeded for a particular period of time.

For this purpose, a second threshold value of S2=6×I_{N} is defined in the digital comparator. The inrush current of I=10×I_{N} at the time T1 thus does not lead to the disconnection of the semiconductor switch because it only occurs for a relatively short period. The inrush current at the time T1 is not recorded at all due to the current profile being sampled at the fixedly predefined times t1, t2, t3, . . . . It is thus only the overload event at the time T2, which lasts for a time interval of AT, that leads to disconnection of the semiconductor switch.

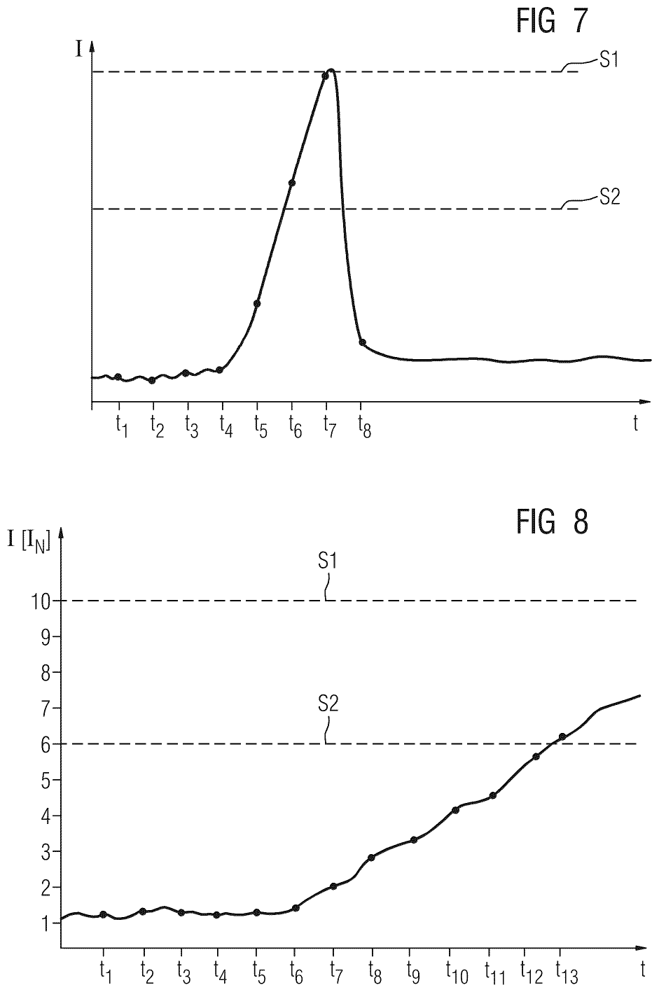

FIG. 7 shows a current profile of a short circuit. Since the current values sampled at the times t4, t5, t6 and t7 result in a change in current dl/dt over a third threshold value S3=(dl/dt)_limit, the corresponding function outputs that there is a short circuit.

FIG. 8 shows a current profile of an overload. Since the current values sampled at the times t5 to t13 result in a change in current dl/dt over a third threshold value S3=(dl/dt)_limit, the corresponding function outputs that there is an overload, for example the motor is blocked.

1. A switching device for protecting an electrical load against overcurrent, comprising:
a load current input for connection to a load current line from a current source and a load current output for connection to a load current line to the electrical load;
a load current path for conducting a current from said load current input to said load current output;
a semiconductor switch connected in said load current path, said semiconductor switch being configured to permit the current through said load current path when said semiconductor switch is switched on and to block the current through the load current path when said semiconductor switch is switched off;
a control circuit configured to switch said semiconductor switch on or off in response to a switching signal;
a current measuring arrangement for recording the current through said load current path;
a controller configured to:
execute an individual function or a combination of two or more functions of at least two predefined functions depending on an operating mode of the electrical load, the functions comparing at least one of a current intensity or a temporal current profile of the current through said load current path with defined threshold values; and
drive said control circuit using a switching signal in dependence on one or more results of the one or more executed functions to switch off said semiconductor switch.

2. The switching device according to claim 1, wherein the at least two functions include:
a first function used to continuously record the current profile in the load current path, to compare same with a first current threshold value, and to output a result of the comparison as a result of the first function;
a second function used to record the current profile in the load current path at particular times, to compare the recorded current values with a second current threshold value, and to output the result of the comparison as the result of the second function; and
a third function used to record the current profile in the load current path at particular times, to compare a change in the current over time for the recorded current values with a current change threshold value, and to output the result of the comparison as the result of the third function.

3. The switching device according to claim 1, comprising a command signal input connected for inputting to said controller a switching command for switching said semiconductor switch.

4. The switching device according to claim 2, comprising an analog comparator enabling the first function to compare a present current value of the current profile in the load current path with a first current threshold value.

5. The switching device according to claim 2, comprising a digital comparator enabling the second function to compare the recorded current values with the second current threshold value and/or the third function to compare a change in the recorded current values over time with the current change threshold value.

6. The switching device according to claim 1, comprising a data memory for storing algorithms of the functions, the algorithms defining circumstances under which said controller outputs a switching signal to said control circuit.

7. A method for protecting an electrical load against overcurrent, the method comprising the following steps:
recording a current through a load current path of a switching device, the load current path conducting the current from a load current input, to which a load current line from a current source is connected, to a load current output, to which a load current line to the electrical load is connected;
providing a semiconductor switch connected in the load current path, the semiconductor switch permitting the current to flow through the load current path when the semiconductor switch is switched on and blocking the current through the load current path when the semiconductor switch is switched off;
providing at least two predefined functions, which compare at least one of a current intensity or a temporal current profile of the current through the load current path with defined threshold values;
executing an individual function or a combination of two or more functions of the predefined functions depending on an operating mode of the electrical load; and
driving the control circuit via a switching signal depending on one or more results of the one or more executed functions to switch off the semiconductor switch and to block the current the load current path.

8. The method according to claim 7, wherein the step of providing the at least two predefined functions comprises providing the following three functions:
a first function used to continuously record a temporal current profile in the load current path, to compare same with a first current threshold value, and to output a result of the comparison as a result of the first function;
a second function used to record a temporal current profile in the load current path at particular times, to compare the recorded current values with a second current threshold value, and to output a result of the comparison as a result of the second function;
a third function used to record a temporal current profile in the load current path at particular times, to compare a change in the current over time for the recorded current values with a current change threshold value, and to output a result of the comparison as a result of the third function.

9. The method according to claim 8, which comprises transmitting the switching signal for switching off the semiconductor switch to the control circuit:
when the result of the first function is that the current in the load current path exceeds the first current threshold value; or
when the result of the second function is that at least one of the recorded current values of the temporal current profile in the load current path exceeds the second current threshold value; or
when the result of the third function is that the change in current over time for the recorded current values exceeds the current change threshold value.

10. The method according to claim 9, wherein the electrical load is an electric motor and the method comprises activating the first function during start-up of the electric motor and activating a combination of the first and second functions or a combination of the first, second, and third functions in rated operation of the electric motor.

11. The method according to claim 8, wherein the electrical load is an electric motor and the method comprises activating the first function during start-up of the electric motor and activating a combination of the first and second functions or a combination of the first, second, and third functions in rated operation of the electric motor.
